(19) United States
(12) Patent Application Publication
(10) Pub. No.: US 2008/0165963 A1
(43) Pub. Date: Jul. 10, 2008

(54) RECEIVING APPARATUS

(76) Inventors: Kenji Wada, Yamato (JP); Hitoshi Akiyama, Machida (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/959,591

(22) Filed: Dec. 19, 2007

(30) Foreign Application Priority Data
Dec. 19, 2006 (JP) 2006-340665

(51) Int. Cl. H04N 7/167

(52) U.S. Cl. 380/240

(57) ABSTRACT

For enabling a counter-program recording when viewing a program, with only one (1) system of POD, a digital broadcast receiving apparatus, for receiving information being scrambled or coded, comprises a display unit for displaying the information being scrambled or coded thereon, a recording unit for recording the information being scrambled or coded, therein; and a controller unit for setting up timing for releasing the information recorded in the recording unit from scrambling or coding thereof, thereby achieving recording of the counter-program, by recording the contents while being descrambled, when recoding the counter-program during when viewing the program, and turning back the stream into POD when a user does not use the receiving apparatus or upon an operation of the user, so as to re-record that descrambled therein.

### BACKGROUND OF THE INVENTION

The present invention relates to a receiving apparatus and a method thereof, enabling a conditional access receiving, and it relates, in particular, to recording or reproducing of so-called a counter-program (i.e., a program broadcasted on a different channel on the same time-zone), for example.

In receiving apparatuses enabling the conditional access receiving, as so-called a receiving apparatus for achieving recording of the counter-program therewith, for example, in the following Patent Document 1 is suggested a technology, “it is an object to provide a digital broadcast recoding/reproducing apparatus for enabling recording of the counter-program, cheaply” (see an abstract).

Also, in the following Patent Document 2 is described the following: “while receiving the digital broadcast with using the conditional access receiving method, that signal broadcasted after being scrambled is recorded, once, as it is, i.e., as the signals scrambled, and descrambling is conducted thereon when reproducing this. Thus, while memorizing the recording EMM (personal information), which is transmitted before starting of the broadcast program, once, into an EMM memory portion 113 of the receiver or a memory within an information processing medium 110, attached with the receiver, the EMM memorized within this receiver is read out when recording the signal of the broadcast program, and it is recorded onto the recoding medium, together with the signal of the broadcast program scrambled and ECM (i.e., program information), and when reproducing, the signal recording on this recoding medium is reproduced (playback), to be views while being descrambled” (see abstract).

[Patent Document 1] Japanese Patent Laying-Open No. 2000-278646 (2000); and

[Patent Document 2] Japanese Patent Laying-Open No. 2000-115091 (2000).

### BRIEF SUMMARY OF THE INVENTION

In recent years, advancement is made on transition or movement into the digital broadcast. In this digital broadcast is used a technology, being called a “conditional access receiving system”. This Conditional Access System (CAS) means a system, wherein, with mounting an IC card or the like, for customer management and accounting management, on receiving equipment, for example, only a specific viewer(s) can receive the broadcast via this IC card or the like, while disenabling other viewer(s) to receive due to the scrambling thereof.

A technology for achieving this conditional access receiving system differs from, depending on undertakers and/or countries. For example, for dissolving the scramble, a B-CAS card (BS-Conditional Access System Card) is adopted within terrestrial digital broadcasts and satellite digital broadcasts in Japan, and in the cable television in Japan and the digital broadcasts in the U.S.A., European countries and Chine, a unit for dissolving coding or descrambling, such as, POD (Point of Deployment), for example, is adopted or is oriented to be adopted, as a removable coding/scrambling dissolving module. Further, this removable coding/scrambling dissolving module may be called a removable coding/scrambling decoding module, from a meaning that it is a removable module, with which the stream coded or descrambled can be decoded. It is removable and is connected with an interface, such as, PCMCIA or USB, etc., for example. Hereinafter, explanation will be given on the POD, as a representative one thereof.

With the B-CAS card, key data for dissolving the coding is transmitted between the receiving apparatuses. It is the main body of the receiving apparatus that executes a process for dissolving the scramble, but not executed within the B-CAS card. Therefore, as in the Patent Document 1, two (2) sets of receiving portions are provided on the side, i.e., the receiving apparatus, so as to let them to have the descramblers, respectively, it is possible to record the counter-program, while conducting the descramble within two (2) receiving portions, simultaneously, even the B-CAS card is in one (1) piece.

On the other hand, POD is a security module, corresponding to CAS. Differing from the B-CAS card, the POD has a function of dissolving the scramble within the POD (i.e., the POD card). Further, within the conventional POD is not provided an interface, for inputting two (2) pieces of transport streams, at the same time, on the different physical channels, which are outputted from two (2) sets of tuners, simultaneously. Therefore, it is impossible to descramble the plural number of transport streams by means of one (1) piece of the POD, and if providing two (2) sets of the receiving portion and the descrambler, as is shown in the Patent Document 1, it is impossible to record the counter-program after descrambling it, by means of the POD. However, for example, if owing the POD card by two (2) pieces, i.e., making two (2) contracts, then a user must pay fee double.

Also, if descrambling when reproducing, as is shown in the Patent Document 2, it is impossible to achieve functions, such as, a multi screen function of displaying recorded programs on a plural number of screens, respectively, during when viewing the programs in receiving, or “picture in picture” function, etc., for example. Also, even when moving the recorded programs into other recording medium or apparatus, legally or lawfully, they cannot be reproduced, if the POD is not installed on that apparatus. In this manner, restrictions are imposed on the functions, and this is inconvenient for the user.

However, the explanation was made on the recording of the counter-program, which is broadcasted through a channel, differing from a certain program (i.e., a true program), within the same time-zone thereof, but there is also the similar problem in the viewing of the counter-program, being viewed while displaying the true program and the counter-program on the plural number of screens, respectively.

Then, for example, with using one (1) piece of POD (i.e., the POD card), recording or viewing of the counter-program is achieved in parallel with the recording or viewing of the true program.

In more details, for example, a stream for use of the counter-program is recorded, once, into a recording/reproducing means, such as, an internal (or built-in) HDD, for example, while being scrambled, and then the stream stored within the recording/reproducing means is read out within a time-zone when the user does not view, or upon an operation of the user, and thereby storing it into the recording/reproducing means, again, after descrambling it through the POD.

With the means mentioned above, for example, it is possible for the user, to record the counter-program while viewing the true program, and thereby to reduce it. And, it is also possible, for example, to display the program(s) recorded during the viewing of other program, when reproducing, and further to conduct reproducing thereof after moving it to other apparatus, which is not yet enable with the POD.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing a structural example 1 of a digital broadcast receiving apparatus, having a counter-program recording function during when viewing with one (1) piece of POD card;

FIG. 2 is a block diagram for showing a structural example 2 of a digital broadcast receiving apparatus, having a counter-program recording function during when viewing with one (1) piece of POD card;

FIG. 3 is a block diagram for showing a structural example 3 of a digital broadcast receiving apparatus, having a counter-program recording function during when viewing with one (1) piece of POD card;

FIG. 4 shows an example of screen for prompting a user to select an ordinary recording program or a counter-program recording program, on a recording program selection screen;

FIG. 5 shows an example of screen for prompting the user to select at which timing descramble should be conducted upon the program recorded, on a selection screen of recorded program descramble;

FIG. 6 shows an example of screen for prompting the user to select on which program descramble should be conducted, when she/he selects “Descramble, just now” in FIG. 5;

FIG. 7 shows an example of screen for prompting the user to select, on which program and when the descramble should be conducted, and to set up date, when she/he selects “Timer Descramble” in FIG. 5;

FIG. 8 shows an example of screen for prompting the user to make a time setup, at which time the descramble should be conducted every day, when she/he selects “Auto descramble” in FIG. 5;

FIG. 9 shows an example of a notice screen to be displayed when the user turns a power source ON during the descrambling or when she/he makes tuning operation; and

FIG. 10 shows an example of a notice screen to be displayed when covering over a recording program during the descrambling.

### DETAILED DESCRIPTION OF THE PREFERRED EMBODIMENTS

Hereinafter, explanation will be given on an embodiment for achieving to record the program scrambled or coded on other channel (i.e., the counter-program) during the viewing of the program scrambled or coded (i.e., the true program), under a condition attached with a restriction that there is only one (1) system of POD, for dissolving the scrambling and coding of a digital stream.

In the embodiment, as an example, explanation will be made on a digital broadcast receiving apparatus for receiving the digital stream of programs, which are scrambled on the digital broadcasting. As the digital broadcast receiving apparatus can be listed up, for example, a HDD recorder, a television receiver, a mobile (portable) phone, a personal computer, etc.

However, the present invention should not be limited to the present embodiment. For example, as will be also explained in the program, it should not be limited only to the program, but may be also called “contents”, broadly. Also, it should not be limited to the digital broadest, it may be the contents, which are transmitted through an IP communication and/or a cable TV network.

### (1) Structural Example

First of all, explanation will be given on the structures of the apparatus and the rolls and the functions thereof.

### (1-1) Structural Example 1

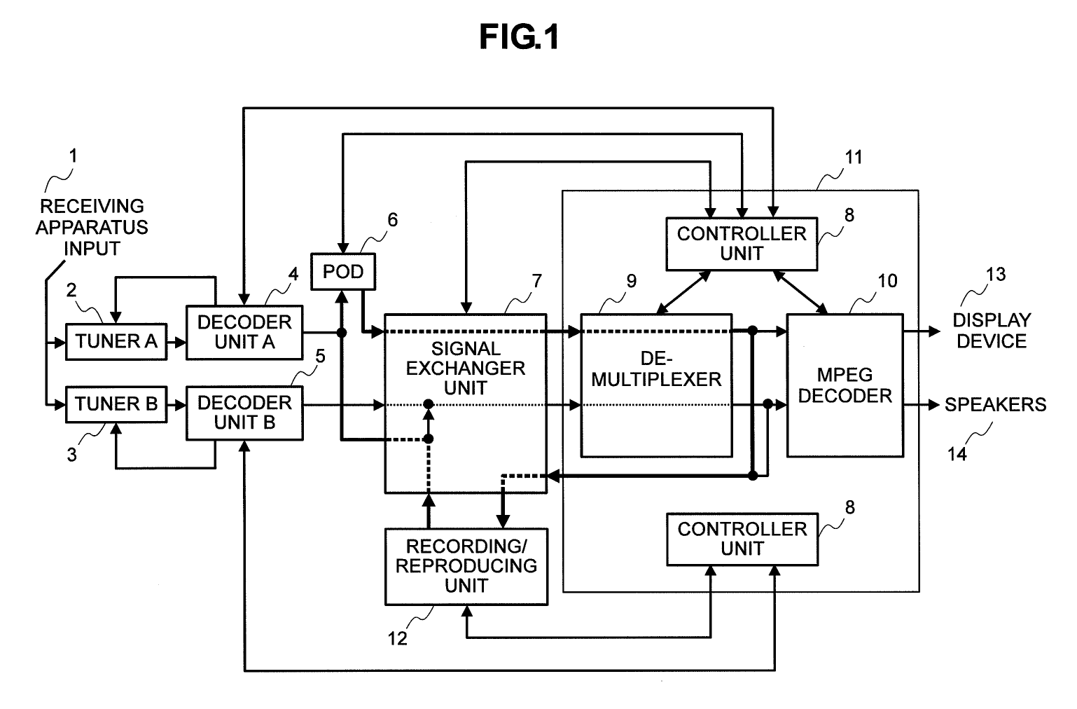

FIG. 1 is a block diagram for showing the structural example of the digital broadcast receiving apparatus. Although being shown in the form of hardware, but it may be constructed in the form of software in a part thereof.

When viewing the television program, a digital broadcast signal is inputted therein, as a receiving apparatus input 1 from a coaxial cable, for example. The signal inputted into the receiving apparatus is supplied into a tuner A2, wherein a desired physical channel is selected from the signal inputted. This selecting or tuning operation is controlled by means of a demodulator portion A4.

The signal outputted from the tuner A2 is supplied into the demodulator portion A4, to be demodulated therein. The signal outputted from the demodulator portion A4 is supplied into a POD portion 6, in which the scramble thereof is dissolved, and it is outputted. The signal outputted from this decoder portion A4 passes through a signal exchanger portion 7, to be supplied into a de-multiplexer 9.

The signal supplied into the de-multiplexer 9 is divided into video data, audio data, etc., and each of them is supplied into a MPEG decoder 10. Within the MPEG decoder 10 the coded video data and the audio data are decoded, and they are outputted as a video signal and an audio signal, respectively. Thus, if being attached with a display apparatus and speakers, the apparatus can be used as a television set.

The decoder portion A4, the POD 6, the signal exchanger portion 7, the de-multiplexer 9 and the MPEG decoder 10 are controlled by means of a controller portion 8. Also in FIG. 1, there is shown a backend LSI having the controller portion 8, the de-multiplexer 9 and the MPEG decoder 10, as an example.

When recording a TV program, an MPEG stream outputted from the de-multiplexer 9, passing through the signal exchanger portion 7, is recorded into a recording/reproducing portion 12. As such recording/reproducing portion 12 can be listed up, such as, a built-in type hard disc drive within a receiver, for example.

When reproducing the contents of recording the TV program, the stream outputted from the recording/reproducing portion 12 is supplied into the de-multiplexer 9 through the signal exchanger portion 7. The streams divided within the de-multiplexer 9 are decoded within the MPEG decoder 10, thereby outputting the video signal and the audio signal.

Next, mentioning will be made on an example of the operation of a simultaneous recording when viewing the TV program. The viewing of TV program is as was mentioned above. Further, in this instance, the signal inputted into the receiving apparatus is supplied into a tuner B3, wherein a desired physical channel is selected from the signal inputted. This tuning operation is controlled by means of a demodulator portion B5. The signal outputted from the tuner B3 is supplied into demodulator portion B5, to be demodulated. The signal outputted from the demodulator portion B5 passes through the signal exchanger portion 7, under the condition of being scrambled, and it is supplied into the de-multiplexer 9.

Also, when being copy-free contents, the program under the viewing can be recorded into the recording/reproducing portion 12 after descrambling process thereon, with using a system of the signal inputted into the tuner B3, while using a system of the signal inputted into the tuner A3 for the program, on which recoding program should be made.

The signal supplied into the de-multiplexer 9 is divided into the video data, and the audio data, etc., and each of them is recorded within the recording/reproducing portion 12, passing through the signal exchanger portion 7. The steam recorded into the recording/reproducing portion 12 cannot be viewed or listen as it is, since the scramble thereof is not yet dissolved.

Then, the scramble may be dissolved depending upon timing or a user operation, etc., when a user does not use a broadcast receiver, yet. Setup on an opportunity or moment when dissolving the scramble will be mentioned later, within explanation of an example of a screen. As the structures and the operation thereof, the stream outputted from the recording/reproducing portion 12 is supplied into the POD 6 through the signal exchanger portion 7. Within the POD 6, this stream is descrambled and it is supplied into the de-multiplexer 9 passing through the signal exchanger portion 7. The streams divided within the de-multiplexer 9 are recorded into the recording/reproducing portion 12 through the signal exchanger portion 7. Since those streams recorded therein are dissolved from the scramble, the video and audio are outputted when reproducing, as mentioned above, so that the user can view and listen them.

### (1-2) Structural Example 2

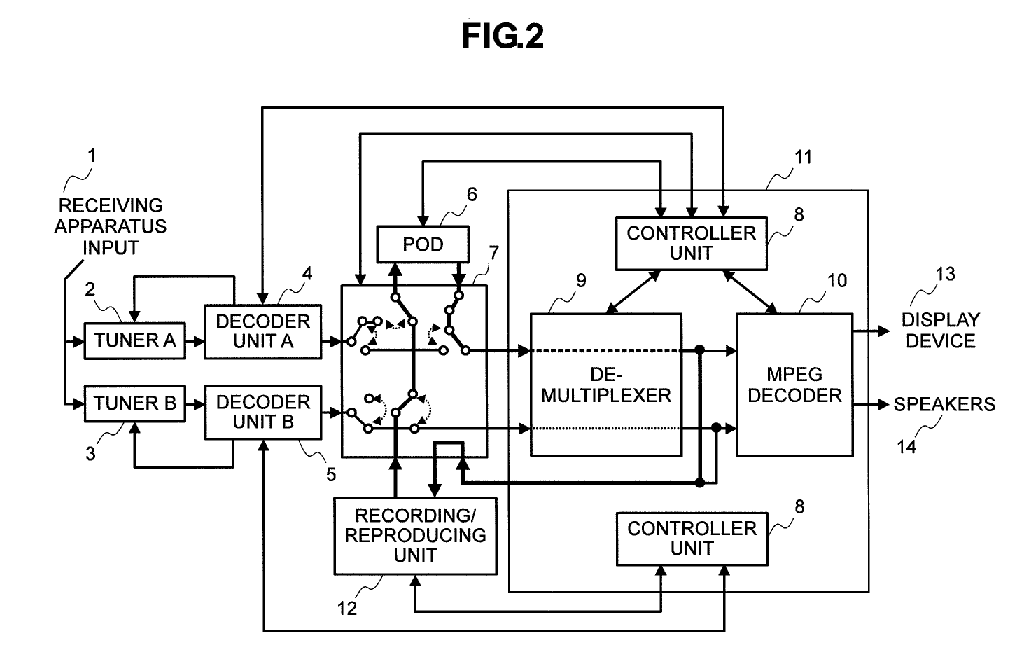

FIG. 2 is a block diagram for showing other example of the structures of the digital broadcast receiving apparatus. The difference lies in the signal exchanger portion 7, i.e., it is positioned behind the output of the demodulator portion A.

Though may be practiced one that can be easily applied for building up the equipment, and the output of the demodulator A is necessarily inputted into the signal exchanger portion through the POD, but in the present figure, it is also possible to make selection of providing the output to the de-multiplexer, but not through the POD. In this instance, for example, in case when receiving a program, on which no scramble is imposed, it is possible to provide the output, directly, into the de-multiplexer on a latter stage, without passing through the POD, and therefore it can bring about an advantage of achieving reduction of consumption on electric power, by stopping supply of the power source to the POD during that time-period.

### (1-3) Structural Example 3

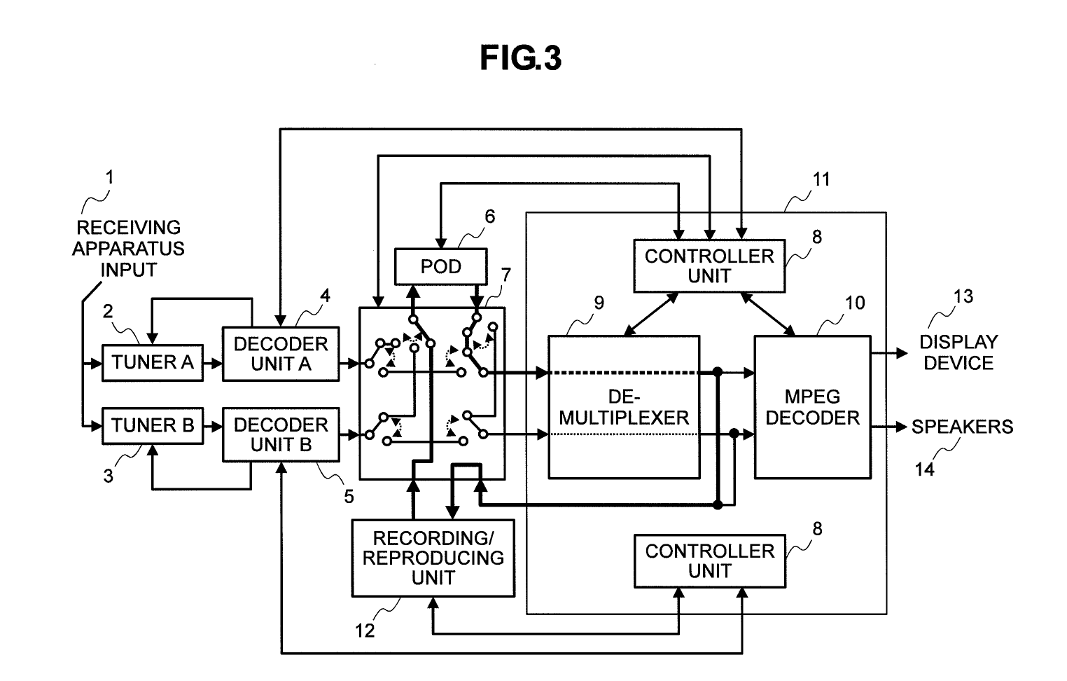

FIG. 3 is a block diagram for showing further other example of the structures of the digital broadcast receiving apparatus. The difference from that shown in FIG. 2 lies in the signal exchanger portion 7.

In the case of this figure, both streams inputted from the demodulator A and the demodulator B can be outputted to the POD side. In FIGS. 1 and 2, although the stream, on which the descrambling can be made is only that, which is inputted form the demodulator A, but in the present figure, since also the stream inputted from the demodulator B can be outputted to the POD side, therefore there can be obtained advantages, i.e., increasing a degree of freedom when controlling with software, and also enabling use without consciousness of distinction between the demodulator A and the demodulator B, so on.

### (2) Screen Example

Hereinafter, explanation will be made on the screen examples to be displayed on the display apparatus shown in FIGS. 1 to 3.

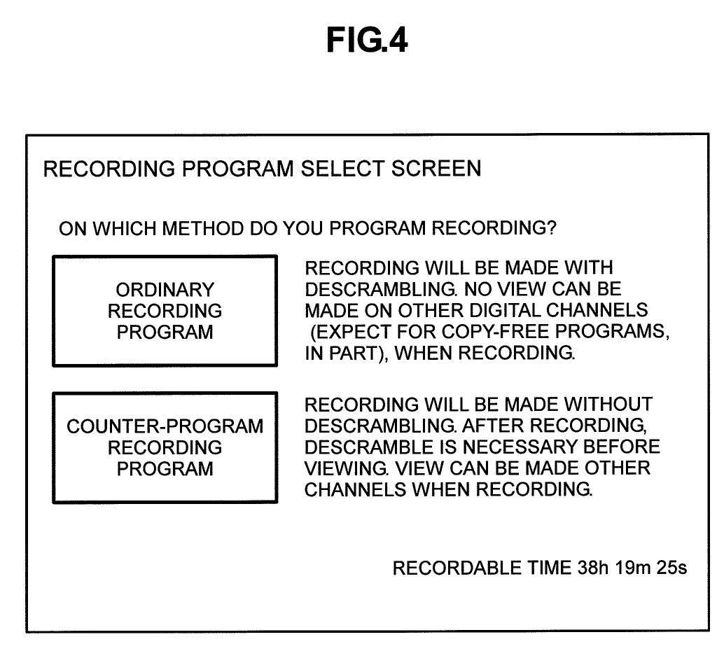

FIG. 4 shows an example of a recording program selection screen.

The recording program selection screen is displayed for prompting the user select one, between an ordinary recording program and a recording program of the counter-program (a counter-program recording program). Selection may be selectively inputted with using buttons of a remote controller (for example, “ordinary recording program” and “counter-program recording program” in FIG. 4), or with using a mouse or a touch-panel (hereinafter, being similar in the explanations of the screen examples). The structures for receiving such selection input may also be called “a selection input portion”, collectively, and the signal thereof is inputted into the controller portion 8.

When selecting the ordinary recording program, it is possible to view the channel under the recording, when recoding, but on the other hand, it is impossible to view other channels. On the contrary, when selecting the counter-program recording program, although it is possible to view the other channel when recording, but since no descramble is made on the program recorded, therefore it is necessary to conduct the descramble before viewing, after the recording thereof.

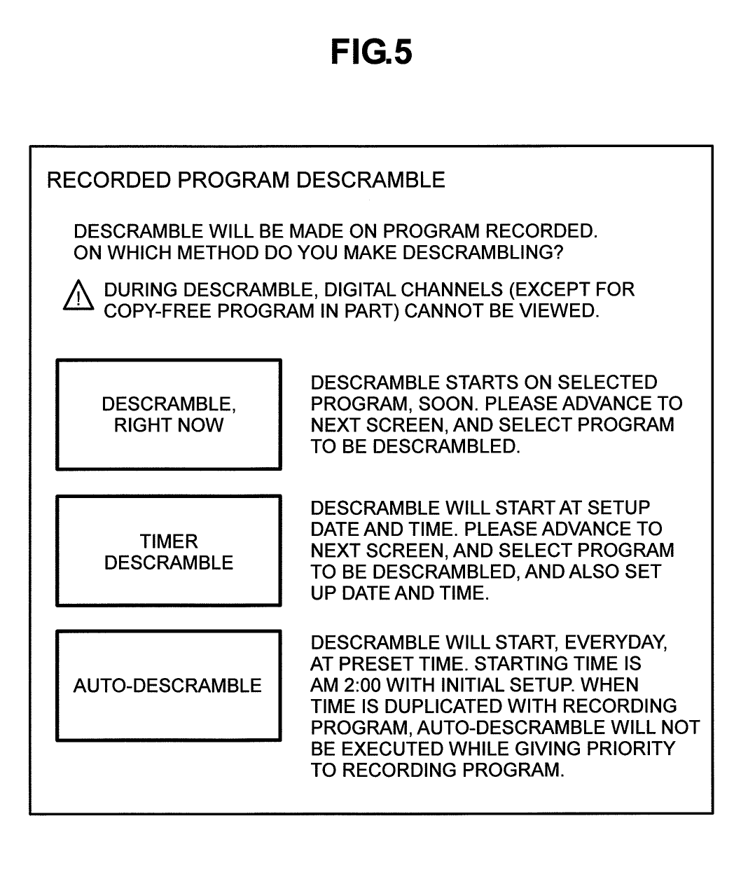

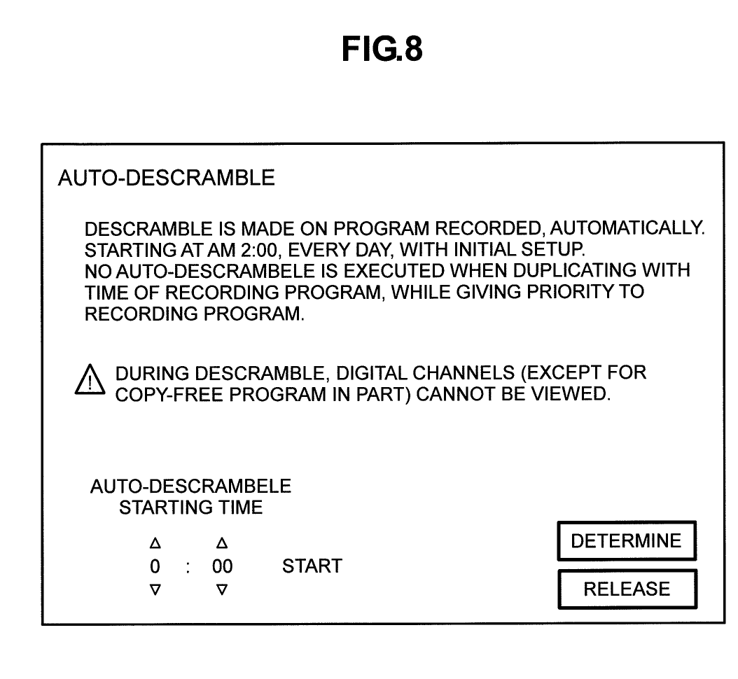

FIG. 8 shows therein an example of a recorded program descramble select screen. With display timing thereof, for example, when pushing down a menu button, during viewing of TV, then “recorded program descramble” is displayed thereon, as a choice. However, herein, it is assumed, that shown in FIG. 4 is a screen for the user to select when recording, and that shown in FIG. 5 appears on the menu to be a choice, only when there are the contents of the program, which is already recorded and not yet descrambled. And, it is also assumed, when the recoding button is pushed down during the viewing, the ordinary recording is conducted, immediately, without displaying the screen shown in FIG. 4, and when making the recording program, there is displayed a selection screen on whether the ordinary recording program should be conducted or the counter-program recording program (i.e., descrambling process after the recording), as shown in FIG. 4.

On the recorded program descramble select screen is made a display for prompting the user to select on which timing descrambling should be conducted on the program recorded. During descrambling, basically, since the program cannot be viewed other than the contents on which the descrambling is conducted, it is so designed that the user can select the timing of conducting the descrambling.

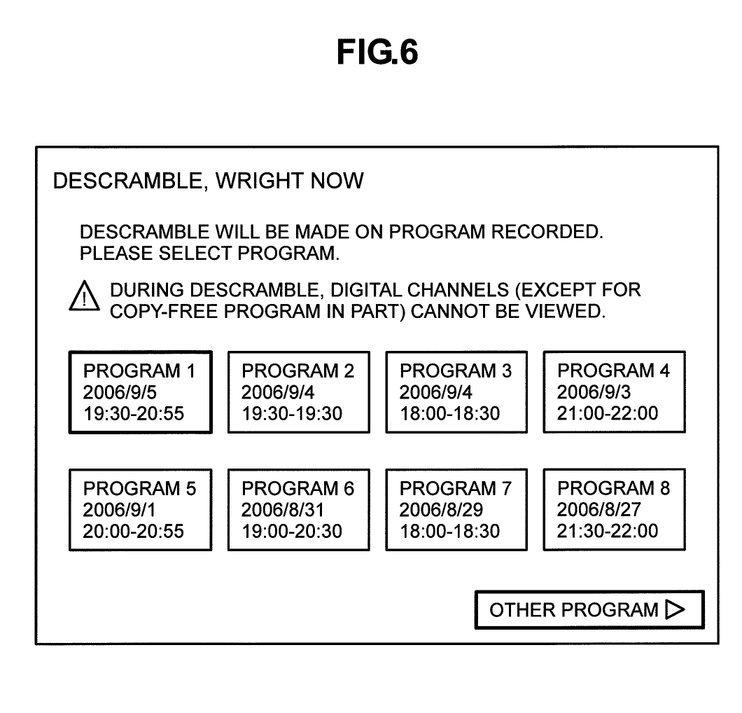

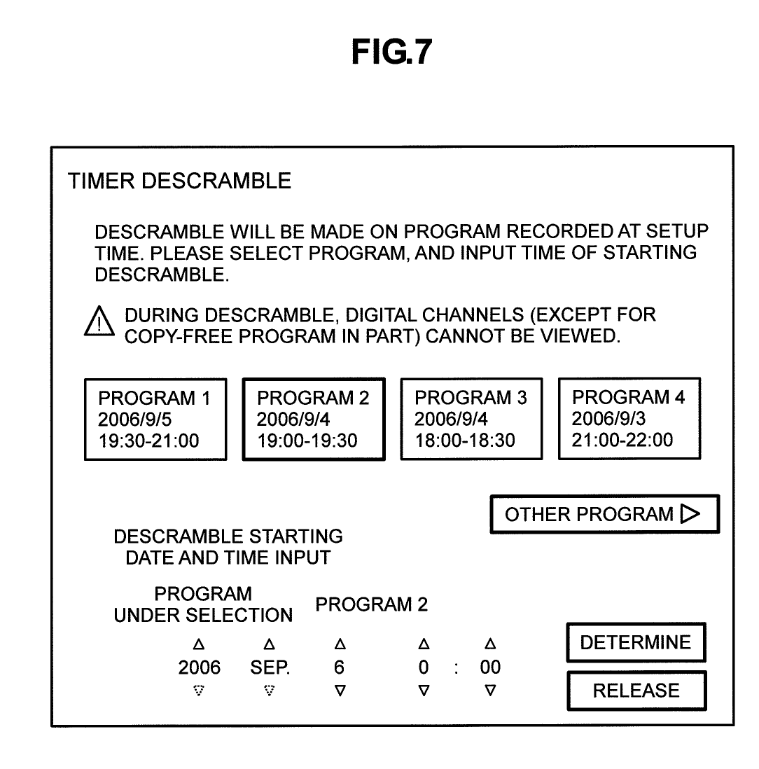

In case when the user wishes to conduct the scrambling, soon, then after selecting “descramble, right now”, on the following screen (see the screen shown in FIG. 6), she/he selects the program, on which the descrambling should be conducted. “auto-descramble” is a function of conducting the descrambling at a predetermined time, every day. If there is a program(s) not yet scrambled, then the scrambling is conducted on it/them at the predetermined time, every day. Setup of the time is conducted on the next screen (see the screen shown in FIG. 8). However, in case where the recording program is already done and the time is duplicated therewith, then the “auto-descramble” will not be executed, while giving priority onto that recording program. A “timer descramble” is similar to that of the “auto-descramble”, but with this, the descrambling is conducted on the date and at the time that the user designate on the program that the user selects. Setup of the date and the time is conducted on the next screen (see the screen shown in FIG. 7).

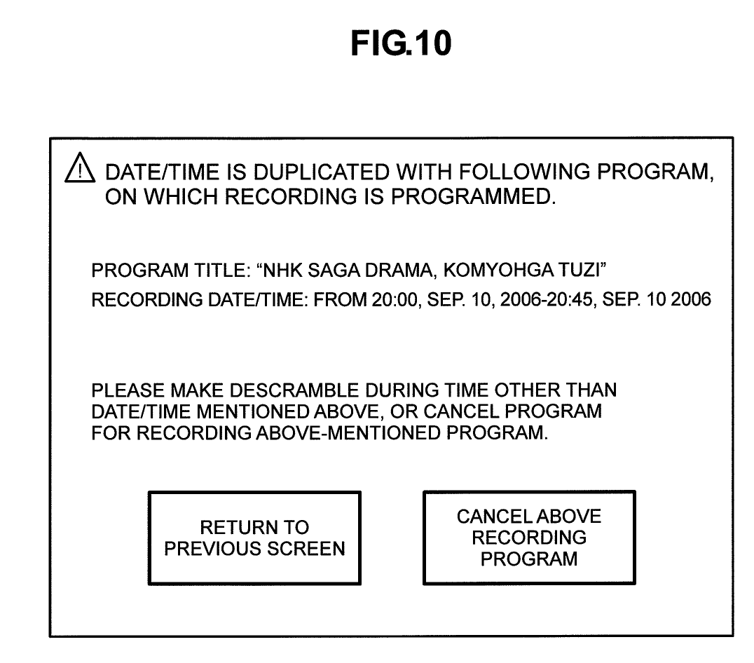

FIG. 6 shows a screen for prompting the user to select the program, on which the scrambling should be made on this screen, in particular, when the user selects the “descramble, just now” on the screen shown in FIG. 5. As is shown in the present figure, if the number of the programs exceeds that of the programs that can be displayed on the screen (for example, eight (8) pieces in the example shown in FIG. 6), the remaining programs can be displayed thereon, by selecting “other program(s)” shown in the figure. Or, when covering over the recording program during the descrambling depending on the length of the program to be descrambled, an alarming notice (see FIG. 10) is displayed, and there are also displayed a program name of the recording program and the date and the time of recording, corresponding thereto, and then waiting until when that program ends, or prompting to select to conduct a cancel of that program, on which the recording program is made.

FIG. 7 shows a screen for prompting a selection, on which program and when the scrambling should be conducted, and also a setup of the date and the time thereof, on that screen, in particular, when the user selects the “timer descramble” on the screen shown in FIG. 5.

As shown in the present figure, when the number of programs exceeds that of programs, which can be displayed thereon (four (4) pieces in the example shown in FIG. 7), the remaining programs can be displayed by selecting “other program(s)” shown in the figure. Also, when pushing down “determine”, finally, after setting up a starting date and time, then the setup of the timer descrambling is completed. And, on the contrary thereto, when wishing to cancel the timer descramble, which was set up once, the user selects the program, which she/he wishes to cancel, and then pushes down a “release” button, thereby enabling cancellation thereof. Further, in similar manner to the “descramble, just now” mentioned above, when covering over the recording program during the descrambling depending on the length of the program to be descrambled, an alarming notice (see FIG. 10) is displayed, and there are also displayed a program name of the recording program and the date and the time of recording, corresponding thereto, and then waiting until when that program ends, or prompting to select to conduct a cancel of that program, on which the recording program is made.

FIG. 8 shows a screen for prompting the user to make a time setup, i.e., when descrambling should be conducted, in every day, in particular, when she/he selects the “auto-descramble” on the screen shown in FIG. 5. As is shown in this figure, when pushing down the “determine” button after setting up the starting time, the setup of the auto-descramble is completed. Also, when not using this “auto-descramble” function, then the present function can be cancelled by pushing down the “release” button on the same screen.

When setting up the “timer descramble” or the “auto-descramble”, the descrambling is executed when it reaches to the time that is determined, under a waiting condition where no viewing is made on the television, i.e., under the condition where a power switch of the television is turned OFF (but, not shutdown on AC).

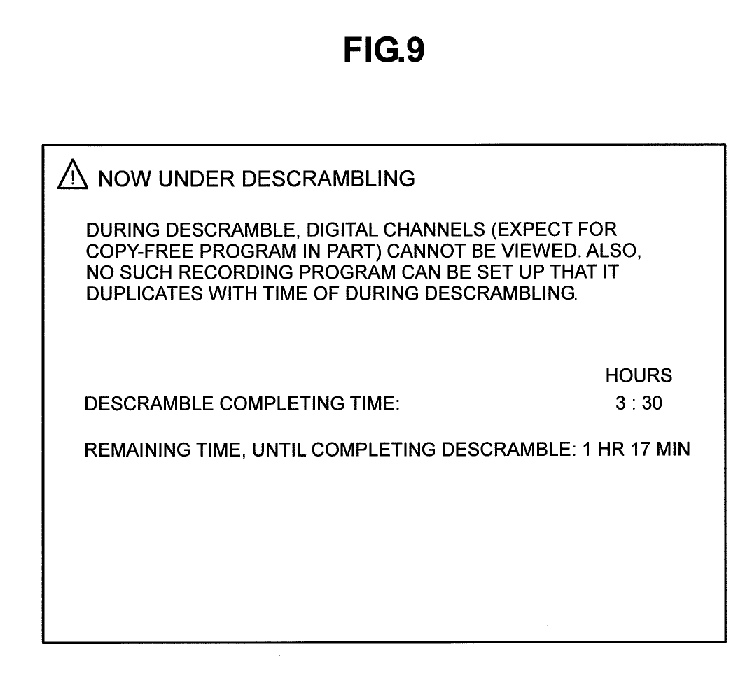

FIG. 9 shows an example of a notice screen to be displayed when the user turns ON the power of the receiving apparatus or conducts the tuning operation, etc., during the descrambling. On this notice screen, there are displayed an finishing time and a time-period until the finishing of the descrambling. Also, if duplication of time occurs, such as, the recoding program starts during the descrambling, for example, when the user tries to set up the recording program during the descrambling, then the recoding program cannot be set up, and that fact is noticed to the user. As is shown in the present figure, it is assumed that the contents under the descrambling and the digital channels, excepting for a part of copy-free programs, cannot be viewed, during the descrambling. However, on the other hand, it is assumed that they can be viewed through analog channels or on external inputs. Also, though not described in the examples, it is assumed that reproduction of other recoded program(s) during the descrambling, depending on the performances or capacity of the recording/reproducing device or apparatus, and further that it/they can be viewed on a receiver having the analog channels and/or the external inputs.

FIG. 10 shows a screen, for displaying an alarm notice when covering on the recording program during the descrambling, depending on the length of the program to be descrambled, and further displaying the name of the program, on which the recording program is made, and also the recording data and time thereof, and thereby prompting to make selection, i.e., between waiting until finishing of the recording of the program or conducting a cancellation of the program, on which the recoding program is made.

As was mentioned above, although the explanation was made that other channels cannot be viewed during the descrambling, but the descrambling on the recorded program may be stopped, temporarily, when the user wishes to watch the television during that scrambling. In this instance, if the descrambling is stopped, temporarily, at where descrambling a part corresponding to 30 minutes on 1-hour program, for example, and then the remaining 30 minutes portion is descrambled after that, and then produced two (2) sets of files are produced within the recording medium (for example, HDD, etc.), then those two (2) sets of files may be associated or referenced with each other, so as to connect them, appropriately. Or, it can be consider to add them into one (1) file.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A receiving apparatus, for receiving information being scrambled or coded, comprising:
a display unit, which is configured to display the information being scrambled or coded, thereon;
a recording unit, which is configured to record the information being scrambled or coded, therein; and
a controller unit, which is configured to set up timing for releasing the information recorded in the recording unit from scrambling or coding thereof.

2. The receiving apparatus, as described in the claim 1, wherein
said controller unit executes the releasing of the information from the scrambling or coding at a time, which is set up to be said timing.

3. The receiving apparatus, as described in the claim 1, wherein
said controller unit executes the releasing of the information from the scrambling or coding for a predetermined program among the information recorded, at a time that is set up for said program.

4. The receiving apparatus, as described in the claim 1, wherein
said controller unit reads out the information recorded into said recording unit, thereby releasing it from the scrambling or coding thereof, and records the information released from the scrambling or coding into said recording unit again.

5. The receiving apparatus, as described in the claim 1, wherein
said display unit displays the information, which is received and released from the scrambling or coding, and the information recorded into said recording unit again, within a screen of said display unit.

6. The receiving apparatus, as described in the claim 1, further comprising
a releasing unit installing unit for installing a releasing unit for releasing from the scramble or coding.

7. The receiving apparatus, as described in the claim 1, wherein
during when a first program is viewed, said controller unit records a second program other than that within said recording unit, under condition of being scrambled and coded and also not de-multiplexed.

8. The receiving apparatus, as described in the claim 1, wherein
said controller unit executes the releasing of scrambling or coding.

9. The receiving apparatus, as described in the claim 1, wherein
a notice is given that scrambled information other than contents under the releasing from scrambling or coding cannot be viewed, or an estimated time until an end of releasing the scrambling or coding, when receiving an operation of a user during when said receiving apparatus releasing the scrambling or coding.

10. The receiving apparatus, as described in the claim 1, wherein
said controller unit receives a setup input for said timing from a user.

11. The receiving apparatus, as described in the claim 10, wherein
said receiving apparatus receives the setup input of an item for executing the scrambling or coding at a time designated, when there is a program recorded, which is not yet released from the scrambling or coding thereof.

12. The receiving apparatus, as described in the claim 11, wherein
said controller unit gives priority to recording program when said time designated and time of the recording program cover on each other.

13. The receiving apparatus, as described in the claim 10, wherein
said controller unit prohibits said setup input or releases the recording program when the timing of said setup input covers on the timing of said recording program.

14. The receiving apparatus, as described in the claim 1, wherein
said controller unit gives a notice or deters to set up a recording program, which covers on timing for releasing the scrambling or coding from the program recorded.

15. A receiving apparatus, comprising:
a plural number of tuner means, each for extracting a signal of a desired physical tuner;
a plural number of decoding means, each for decoding the signal extracted within said tuner means and outputting a digital stream therefrom;
a releasing means for releasing scrambling or coding of the stream outputted by said decoding means;
a dividing means for dividing the digital stream;
a recoding/reproducing means for recording the digital stream to a recording medium, and also, for reading out the digital stream recorded;
an exchange means for exchanging input/output of said releasing means, said dividing means and said recording/reproducing means; and
an MPEG decoder for decoding the signal inputted from said dividing mean, for providing an output.

16. The receiving apparatus, as described in the claim 15, wherein
said releasing means is a removable coding/scrambling releasing module.

17. The receiving apparatus, as described in the claim 15, wherein
said controller unit makes said recording/reproducing unit record the digital stream of contents to be recorded after releasing the scrambling or coding thereof with using said releasing means, but without using said releasing means for the contents to be viewed, when the contents under viewing is contents of copy-free while the contents to be recorded is contents scrambled or coded.

18. The receiving apparatus, as described in the claim 15, wherein
the contents to be viewed is released from the scrambling or coding thereof with using said releasing means, but without using said releasing means for the contents to be recorded, when the contents to be viewed is contents scrambled or coded while the contents to be recorded is contents of copy-free.

19. A receiving apparatus, comprising:
a plural number of tuner means, each for extracting a signal of a desired physical tuner;
a plural number of decoding means, each for decoding the signal extracted within said tuner means and outputting a digital stream therefrom;
a releasing means for releasing scrambling or coding from a digital stream;
a dividing means for dividing the digital stream;
a recoding/reproducing means for recording the digital stream to a recording medium, and also, for reading out the digital stream recorded;
an exchange means for exchanging input/output of said releasing means, said dividing means and said recording/readout means; and
an MPEG decoder for decoding the signal inputted from said dividing mean, for providing an output.

20. The receiving apparatus, as described in the claim 19, wherein
said releasing means is a removable coding/scrambling releasing module.

21. The receiving apparatus, as described in the claim 19, wherein
said controller unit makes said recording/reproducing unit record the digital stream of contents to be recorded after releasing the scrambling or coding thereof with using said releasing means, but without using said releasing means for the contents to be viewed, when the contents under viewing is contents of copy-free while the contents to be recorded is contents scrambled or coded.

22. The receiving apparatus, as described in the claim 19, wherein
the contents to be viewed is released from the scrambling or coding thereof with using said releasing means, but without using said releasing means for the contents to be recorded, when the contents to be viewed is contents scrambled or coded while the contents to be recorded is contents of copy-free.
